(19) United States
(12) Patent Application Publication
(10) Pub. No.: US 2025/0392813 A1
(43) Pub. Date: Dec. 25, 2025

(54) TIME DISTRIBUTION APPARATUS

(71) Applicant: CANON KABUSHIKI KAISHA, Tokyo (JP)

(72) Inventor: MOTOHARU SUZUKI, Kanagawa (JP)

(21) Appl. No.: 19/243,286

(22) Filed: Jun. 19, 2025

(30) Foreign Application Priority Data
Jun. 25, 2024 (JP) 2024-101992

(51) Int. Cl. H04N 23/60; H04N 23/661; H04N 23/90; H04N 25/76

(52) U.S. Cl. CPC H04N 23/665; H04N 23/661; H04N 23/90; H04N 25/7795

(57) ABSTRACT

A time distribution apparatus includes a first transmission unit that transmits, to a first external apparatus, time information based on a value of a first time counter for a first synchronization processing, a second transmission unit that transmits, to a second external apparatus, time information based on a value of a second time counter for a second synchronization processing, and a correction unit that executes correction to match the value of the first time counter and the value of the second time counter to each other.

### FIELD

The present disclosure relates to a time distribution apparatus, a synchronized image capturing system, a processing method of the time distribution apparatus, and a storage medium.

### DESCRIPTION OF THE RELATED ART

In recent years, there has been an increased number of cases where electronic devices, such as digital cameras, printers, mobile phones, and smartphones, having wireless communication functions, are connected to a wireless network and used.

Japanese Patent Application Laid-Open No. 2016-66898 describes a technique for implementing synchronized shutter operation across a plurality of digital cameras by causing a digital camera operating as a subunit to execute time synchronization with a digital camera operating as a base unit by using a wireless communication packet.

Japanese Patent Application Laid-Open No. 2020-77929 describes a technique for reducing a difference between time distributed to/from apparatuses in a redundant synchronized network using a plurality of time distribution apparatuses.

In a case where communication methods (wired/wireless communication) and time synchronization mechanisms of cameras are different from each other when synchronized image capturing is to be implemented by the cameras, a time distribution apparatus is required to support a plurality of time distribution methods. Further, the time information distributed is required to be appropriately handled among the plurality of distribution methods, to prevent degradation of synchronization accuracy of the entire system.

The present disclosure is directed to a technique for reducing a difference between values output from time counters that are used for a plurality of pieces of synchronization processing.

### SUMMARY

According to another aspect of the present disclosure, a time distribution apparatus includes a first transmission unit configured to transmit, to a first external apparatus, time information based on a value of a first time counter for a first synchronization processing, a second transmission unit configured to transmit, to a second external apparatus, time information based on a value of a second time counter for a second synchronization processing, and a correction unit configured to execute correction to match the value of the first time counter and the value of the second time counter to each other.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of a synchronized image capturing system including a plurality of cameras.

FIG. 2 is a block diagram illustrating a configuration example of a time distribution apparatus.

FIG. 3 is a block diagram illustrating a configuration example of a timer control unit.

FIG. 4 is a diagram illustrating a software group that is executed by a control unit.

FIG. 5 is a flowchart illustrating a processing method that is executed by the time distribution apparatus.

FIG. 6 is a diagram illustrating time synchronization using Precision Time Protocol (PTP).

FIG. 7 is a flowchart illustrating common synchronization that is executed by the control unit.

FIG. 8 is a diagram illustrating time synchronization using Fine Time Measurement (FTM).

FIG. 9 is a flowchart illustrating wireless synchronization that is executed by a wireless control packet processing unit.

FIG. 10 is a timing chart illustrating time adjustment processing.

FIG. 11 is a diagram illustrating another configuration example of a synchronization system including a plurality of cameras.

FIG. 12 is a block diagram illustrating another configuration example of a time distribution apparatus.

FIG. 13 is a timing chart illustrating time adjustment processing.

### DESCRIPTION OF THE EMBODIMENTS

The following describes the time distribution apparatus according to the present embodiments with reference to the drawings. It should be noted that the technical scope of the present disclosure is defined by the claims, and is not limited by the following individual embodiments.

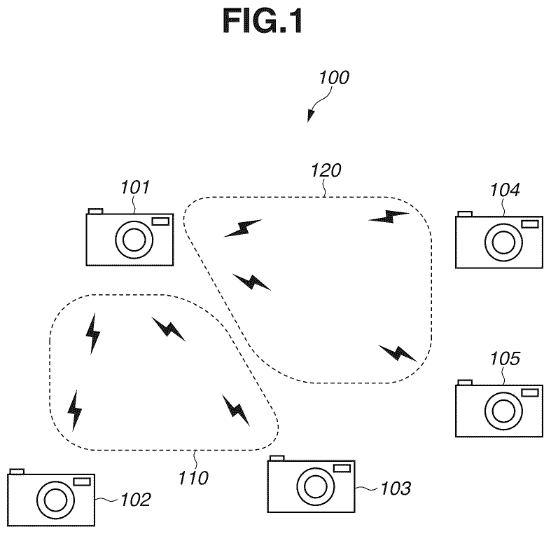

FIG. 1 is a diagram illustrating a configuration example of a synchronized image capturing system 100 according to a first embodiment. The synchronized image capturing system 100 includes a time distribution apparatus 101, a plurality of cameras 102 to 105, and wireless networks 110 and 120.

The time distribution apparatus 101 operates as a base unit of the wireless networks 110 and 120 to establish the wireless networks 110 and 120 with the cameras 102 to 105. Herein, a wireless communication method using a wireless local area network (LAN) compliant with IEEE 802.22 series is described as an example. Examples of the Wireless communication method include near field wireless communication, such as Near Field Communication (registered trademark) (hereinafter, called “NFC”) and Bluetooth®. The time distribution apparatus 101 may be configured to use in combination with some or all wireless communication methods, or may be configured in such a manner that some or all wireless communication methods are implemented as a separate functional block.

The time distribution apparatus 101 has a function for executing time distribution to the cameras 102 to 105 and transmits control information for synchronized image capturing. Similar to the cameras 102 to 105, the time distribution apparatus 101 may also has an image capturing function and may participate in the synchronized image capturing.

The time distribution apparatus 101 and the cameras 102 to 105 are able to execute synchronized image capturing at a same timing by communicating the control information for the synchronized image capturing. The time distribution apparatus 101 executes time distribution, so that time of each of the cameras 102 to 105 is corrected to time same as the time of the time distribution apparatus 101. Therefore, synchronized image capturing is able to be executed by the time distribution apparatus 101 and the cameras 102 to 105.

Each of the cameras 102 and 103 executes time synchronization processing with the time distribution apparatus 101 by implementing a time synchronization method using a protocol unique to wireless communication (hereinafter, called “wireless synchronization method”) with the time distribution apparatus 101. Each of the cameras 102 and 103 executes image capturing according to the time synchronization processing using the wireless synchronization method.

Each of the cameras 104 and 105 executes time synchronization processing with the time distribution apparatus 101 by implementing a time synchronization method applicable regardless of wireless or wired communication (hereinafter called “common synchronization method”). Each of the cameras 104 and 105 executes image capturing according to the time synchronization processing using the common synchronization method.

The above-described methods are described below in detail. The configuration example illustrated in FIG. 1 has been described.

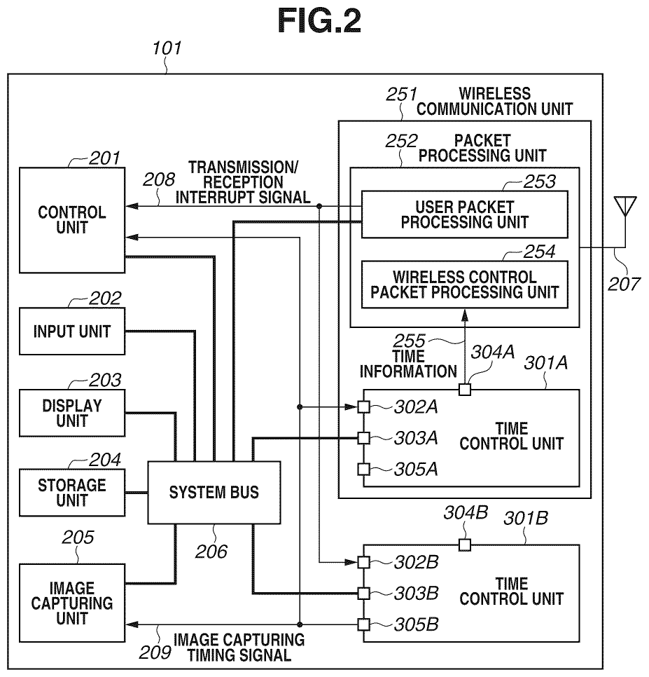

FIG. 2 is a block diagram illustrating a configuration example of the time distribution apparatus 101 illustrated in FIG. 1. The time distribution apparatus 101 includes a control unit 201, an input unit 202, a display unit 203, a storage unit 204, an image capturing unit 205, a system bus 206, a wireless communication unit 251, and a time control unit 301B. The wireless communication unit 251 includes an antenna 207, a packet processing unit 252, and a time control unit 301A. The packet processing unit 252 includes a user packet processing unit 253 and a wireless control packet processing unit 254.

The control unit 201 executes control programs stored in the storage unit 204 to control entire operation of the time distribution apparatus 101. The control programs are described below. For example, the control unit 201 includes a central processing unit (CPU).

The input unit 202 is an apparatus that is used by a user to input various types of information, and has an operation function for operating the time distribution apparatus 101.

The display unit 203 is a unit having a function for outputting and displaying various types of visually-recognizable information, which is a liquid crystal display (LCD) or a light-emitting diode (LED), for example.

The storage unit 204 stores the control programs that are executed by the control unit 201, captured image data generated by the image capturing unit 205, and a communication packet that is used to transmit/receive information to/from another device through wireless/wired communication.

The image capturing unit 205 is a block which generates an image by executing image capturing processing. The image capturing unit 205 has a mode in which the image capturing unit 205 operates at a timing instructed via a system bus 206, and a mode in which the image capturing unit 205 executes primitive timing control according to an image capturing timing signal 209. The image capturing unit 205 executes image capturing processing according to the image capturing timing signal 209.

The wireless communication unit 251 is a wireless communication unit for executing wireless LAN communication. The wireless communication unit 251 includes a packet processing unit 252 for executing packet transmission/reception processing, a time control unit 301A for managing time information associated with the packet processing, and an antenna 207 that is used for the wireless communication.

The packet processing unit 252 includes the user packet processing unit 253 which mainly executes processing for transmitting and receiving an internet protocol (IP) packet that is used by a user/an application. The IP packet is a packet processed as a data frame in the wireless LAN. The packets handled in the packet processing unit 252 include any type of packet except for a Precision Time Protocol (PTP) packet that is used for the synchronization processing described below-. For example, an image packet to be used when transmission/reception of image information is required in synchronized image capturing and various control packets to be used when synchronized image capturing is implemented are processed as user packets.

A transmission/reception interrupt signal 208 is asserted at a timing when the packet is transmitted/received.

The transmission/reception interrupt signal 208 is input to the control unit 201 and the time control unit 301B described below. In a case where a user packet is received, the packet is stored in the storage unit 204.

The packet processing unit 252 includes the wireless control packet processing unit 254. The wireless control packet processing unit 254 executes processing relating to a management frame and a control frame to be used to execute wireless communication between wireless LAN terminals. Processing for distributing time to the cameras 102 and 103 using the wireless synchronization method is also executed by the wireless control packet processing unit 254.

Time information 255 is input to the wireless control packet processing unit 254 from the time control unit 301A. The time information 255 is used to control various processing timings to be used for execution of time distribution using the wireless synchronization method, storing the processing timings, and inserting time to the packet. The time information 255 is generated and supplied by the time control unit 301A.

In the below descriptions, an element with a reference numeral having a suffix “A” indicates the time control unit 301A or a constituent element of the time control unit 301A. Similarly, an element with a reference numeral having a suffix “B” indicates the time control unit 301B or a constituent element of the time control unit 301B. Hereinafter, the time control units 301A and 301B are each generally called as a time control unit 301.

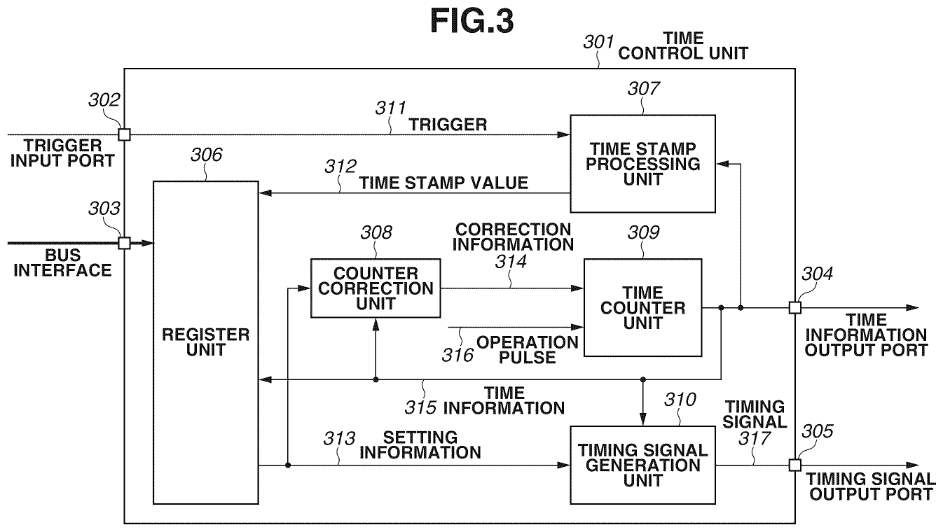

FIG. 3 is a block diagram illustrating a configuration example of the time control unit 301. The time control unit 301A supplies time information 255 to the wireless control packet processing unit 254. The time control unit 301 is applicable to both the time control units 301A and 301B illustrated in FIG. 2. The time control unit 301 is described in detail with reference to FIG. 3.

The time control unit 301 includes a trigger input port 302, a bus interface 303, a time information output port 304, and a timing signal output port 305. The time control unit 301 further includes a register unit 306, a time stamp processing unit 307, a counter correction unit 308, a time counter unit 309, and a timing signal generation unit 310.

The time stamp processing unit 307 receives time information 315 whose value is successively updated, which is output from the time counter unit 309, and a trigger 311 input via the trigger input port 302. The time stamp processing unit 307 functions to store the time information 315 at a timing when the trigger 311 is detected and to output the time information 315 as a time stamp value 312.

The time counter unit 309 is a counter which indicates time. The time counter unit 309 counts a value according to an operation pulse 316. The time counter unit 309 functions to execute correction based on correction information 314 received from the counter correction unit 308.

The correction information 314 includes information about a correction method and a correction amount to be used for the correction method. Three types of correction methods may be used. Firstly, a value output from the time counter unit 309 is directly overwritten (i.e., direct value correction method). Secondly, an addition/subtraction value is acquired for a value output from the time counter unit 309, and the value is corrected by the addition/subtraction value through additive/subtractive correction (i.e., offset correction method). Thirdly, a value output from the time counter unit 309 is increased when the operation pulse 316 occurs, i.e., correction is executed with respect to a time advance amount per unit time (i.e., frequency correction method).

The timing signal generation unit 310 functions to output a timing signal 317 having a fixed frequency. The timing signal generation unit 310 is able to generate the timing signal 317 having a fixed frequency by changing a signal value to 1 or 0 every time a value of the time information 315 is advanced by a predetermined amount. A setting of when to start generating a timing signal 317 in what frequency is performed by setting information 313.

The register unit 306 is a register that is accessed by the control unit 201 and to which setting information 313 to be transmitted to the counter correction unit 308 and the timing signal generation unit 310 is set. The register unit 306 is able to check the time information 315 and the time stamp value 312.

The time control unit 301 has the trigger input port 302, the time information output port 304, the timing signal output port 305, and the bus interface 303 as interfaces to the outside. The time control unit 301 has been described.

Referring back to descriptions of the time control unit 301A in FIG. 2. The time control unit 301A receives the image capturing timing signal 209 output from a time control unit 301B described below via a trigger input port 302A, and generates a time stamp. In the present embodiment, a timing signal output port 305A is not used. The time control unit 301A has been described.

The time control unit 301B is described. The time control unit 301B manages time information to be used for the common synchronization method. The time control unit 301B plays a role in generating the image capturing timing signal 209 to be input to the image capturing unit 205. A timing signal generation unit 310B included in the time control unit 301B generates the image capturing timing signal 209 according to the time information 315 output from a time counter unit 309B. As for a frequency of the image capturing timing signal 209, a frame rate may be used, for example. In a case where a timing is separately generated by the image capturing unit 205, a pulse per second (PPS) signal of 1 Hertz (Hz) may be generated as a signal to be used for synchronization. In the present embodiment, a time information output port 304B is not used. The time control unit 301B is described.

The image capturing timing signal 209 is also input to the control unit 201, so that the control unit 201 is able to detect the image capturing timing. The control unit 201 generates a time stamp by using occurrence of a transmission/reception interrupt signal 208 as a trigger. This time stamp is used for the common synchronization method. Details are described below.

The system bus 206 is used when the control unit 201 accesses respective function blocks and when various types of data, such as packet data and captured image data, are transmitted. The configuration example illustrated in FIG. 2 has been described.

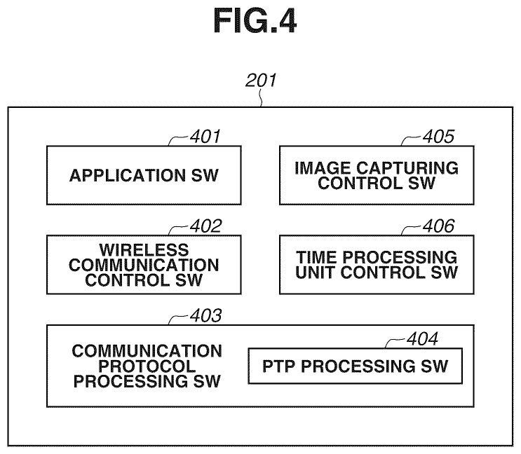

FIG. 4 is a diagram illustrating pieces of software that are executed by the control unit 201. Application software 401 is software for various applications that are implemented by the time distribution apparatus 101. Image capturing control software 405 is software for controlling the image capturing unit 205. Wireless communication control software 402 is software for controlling the wireless communication unit 251. Time processing unit control software 406 is software for controlling the time control units 301A and 301B. Communication protocol processing software 403 is software for executing processing of various communication protocols. PTP processing software 404 for executing processing for PTP, that is used for the common synchronization method, is also included in the communication protocol processing software 403. The software illustrated in FIG. 4 has been described.

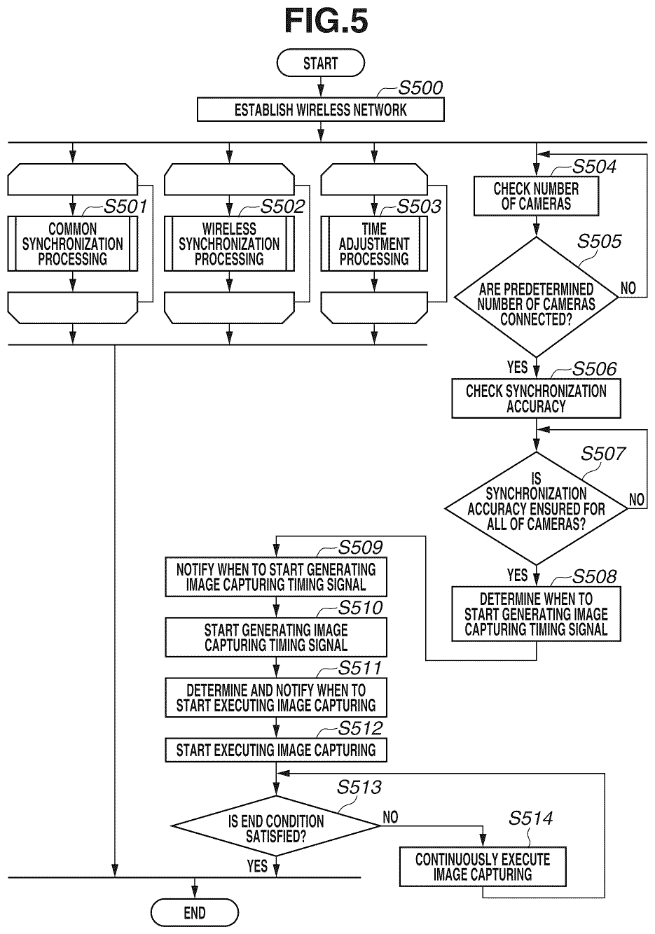

Operation that is executed by the time distribution apparatus 101 is described. First, overall processing is described with reference to a flowchart illustrated in FIG. 5.

FIG. 5 is a flowchart illustrating a processing method that is executed by the time distribution apparatus 101. In step S500, the control unit 201 establishes a wireless LAN network via the wireless communication unit 251, and wirelessly connect the cameras 102 to 105. Then, the control unit 201 concurrently and continuously executes the processing in steps S501 to S504.

In step S501, the control unit 201 executes common synchronization processing for synchronizing time with the cameras 104 and 105 by using a value output from the time counter unit 309B of the time control unit 301B. Details of this processing are described below.

In step S502, the control unit 201 executes wireless synchronization processing for synchronizing time with the cameras 102 and 103 by using a value output from a time counter unit 309A of the time control unit 301A. Details of this processing are described below.

In step S503, the control unit 201 executes time adjustment processing for eliminating a time difference between the common synchronization method and the wireless synchronization method. Details of this processing are described below.

Details of the above-described processing executed in three steps, S501 to S503, are described below. Further, the control unit 201 separately executes processing for executing synchronized image capturing (i.e., the processing in steps S504 and subsequent steps) while establishing and maintaining the synchronized state of all of the cameras 102 to 105 and the time distribution apparatus 101 through the processing in three steps S501 to S503.

In step S504, the control unit 201 checks the number of cameras 102 to 105 to execute the synchronized image capturing. The control unit 201 may use information about the number of cameras if the number of cameras is able to be acquired in respective synchronization methods, or may include an additional application for checking the number of cameras if the number of cameras is not able to be acquired in respective synchronization methods.

In step S505, the control unit 201 determines whether the predetermined number of cameras 102 to 105 are connected. In a case where the predetermined number of cameras 102 to 105 are connected (YES in step S505), the processing proceeds to step S506. In a case where the predetermined number of cameras 102 to 105 are not connected (NO in step S505), the processing returns to step S504.

In step S506, the control unit 201 checks the synchronization accuracy of the cameras 102 to 105. The control unit 201 may include an application for acquiring feedback about the synchronization accuracy from the respective cameras 102 to 105, or may use the synchronization accuracy in respective synchronization methods if the synchronization accuracy is able to be checked in respective synchronization methods.

In step S507, the control unit 201 determines whether required synchronization accuracy is ensured for all of the cameras 102 to 105. In a case where required synchronization accuracy is ensured for all of the cameras 102 to 105 (YES in step S507), the processing proceeds to step S508. In a case where required synchronization accuracy is ensured for not all of the cameras 102 to 105 (NO in step S507) the processing returns to step S507.

In step S508, the control unit 201 determines when to start generating the image capturing timing signal 209.

In step S509, the control unit 201 notifies determined time to start generating the image capturing timing signal 209 to the respective cameras 102 to 105 through the wireless communication unit 251. Because this notification is transmitted via the wireless networks 110 and 120, the above-described start time has to be determined by factoring in network delay and processing latency of the cameras 102 to 105.

In step S510, the control unit 201 executes processing for starting the generation of the image capturing timing signal 209 via the time control unit 301B. In the processing, the control unit 201 sets the setting information 313 to be transmitted to the timing signal generation unit 310 of the time control unit 301B to the register unit 306. By this processing, the cameras 102 to 105 and the time distribution apparatus 101 start generating the image capturing timing signal 209 at the same time, so that the cameras 102 to 105 and the time distribution apparatus 101 are ready for a timing signal for execution of synchronized image capturing.

In step S511, the control unit 201 determines when to start executing image capturing, and notifies the determined start time to all of the cameras 102 to 105.

In step S512, in a case where the time distribution apparatus 101 includes the image capturing unit 205, the control unit 201 starts executing image capturing via the image capturing unit 205.

In step S513, the control unit 201 determines whether an end condition is satisfied. In a case where an end condition is satisfied (YES in step S513), the processing in the flowchart in FIG. 5 is ended. In a case where an end condition is not satisfied (NO in step S513), the processing proceeds to step S514.

In step S514, the control unit 201 continuously executes the synchronized image capturing. Then, the processing returns to step S513. The processing in FIG. 5 has been described.

The common synchronization method is described. A synchronization method using PTPv2 protocol (hereinafter, called “PTP”) defined in IEEE 1588-2008 is described as an example of the common synchronization method.

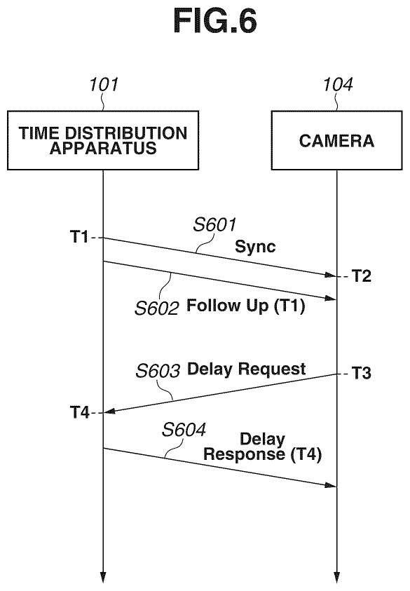

FIG. 6 is a diagram illustrating PTP processing. In a case of using PTP, synchronization processing is executed by periodically transmitting and receiving four packets, i.e., a Synchronization (Sync) packet (in step S601), a Follow Up packet (in step S602), a Delay Request packet (in step S603), and a Delay Response packet (in step S604) to/from the terminals.

In step S601, the time distribution apparatus 101 transmits a Sync packet at a time T1. The camera 104 receives the Sync packet at a time T2.

In step S602, the time distribution apparatus 101 transmits a Follow Up packet including information about the time T1. The camera 104 receives the Follow Up packet including the information about the time T1.

In step S603, the camera 104 transmits a Delay Request packet at a time T3. The time distribution apparatus 101 receives the Delay Request packet at a time T4.

In step S604, the time distribution apparatus 101 transmits a Delay Response packet including information about the time T4. The camera 104 receives the Delay Response packet including the information about the time T4.

The time T1 is time that indicates a timing when the Sync packet is transmitted in step S601 and is acquired by a clock included in the time distribution apparatus 101.

The time T2 is time that indicates a timing when the Sync packet is received in step S601 and is acquired by a clock included in the camera 104.

The Time T3 is time that indicates a timing when the Delay Request packet is transmitted in step S603 and is acquired by the clock included in the camera 104.

The time T4 is time that indicates a timing when the Delay Request packet is received in step S603 and is acquired by the clock included in the time distribution apparatus 101.

From among the packets transmitted to the camera 104 from the time distribution apparatus 101, the Follow Up packet transmitted in step S602 includes the information about the time T1, and the Delay Response packet transmitted in step S604 includes the information about the time T4.

Through the above-described processing, the camera 104 is able to acquire the information about the times T1, T2, T3, and T4. Transmission delay time as network delay time and an offset as a time difference between the time distribution apparatus 101 and the camera 104 is able to be calculated from the information about the times T1, T2, T3, and T4 by the following formulas.

$$Transmission Delay Time = ( ( T 2 - T 1 ) + ( T 4 - T 3 ) ) / 2$$

$$Offset = ( ( T 2 - T 1 ) - ( T 4 - T 3 ) ) / 2$$

For example, the camera 104 is able to correct time indicated by the clock included in the camera 104 by adding the transmission delay time to the time T1 (T1+Transmission Delay Time), or by subtracting the offset from the time T2 (T2−Offset). In this way, time indicated by the clock included in the camera 104 is able to be adjusted to time indicated by the clock included in the time distribution apparatus 101. The PTP processing has been described.

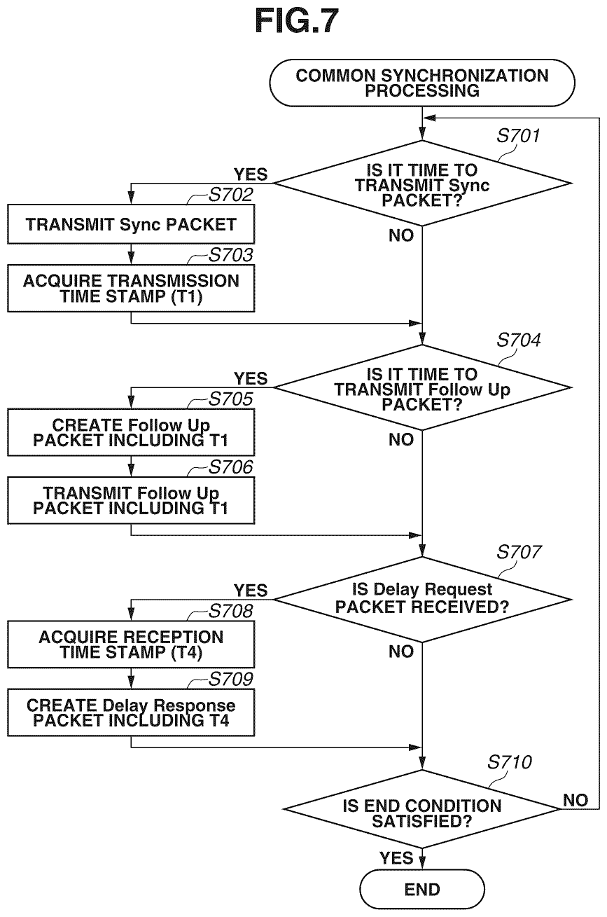

FIG. 7 is a flowchart illustrating details of the common synchronization processing that is executed by the time distribution apparatus 101 in step S501 of FIG. 5.

In step S701, the control unit 201 determines whether it is time to transmit a Sync packet. In a case where the control unit 201 determines that it is time to transmit a Sync packet (YES in step S701), the processing proceeds to step S702. In a case where the control unit 201 determines that it is not time to transmit a Sync packet (NO in step S701), the processing proceeds to step S704.

In step S702, the control unit 201 functions as a transmission unit to transmit a Sync packet to the camera 104 or 105 via the wireless communication unit 251 by using the wireless network 120. The control unit 201 is able to implement the processing in step S702 by creating a Sync packet in the storage unit 204 via the PTP processing software 404 and issuing a transmission instruction to the wireless communication unit 251. The cameras 104 and 105 are examples of the external apparatuses.

In step S703, at a timing when transmission of the Sync packet has been completed, the wireless communication unit 251 asserts the transmission/reception interrupt signal 208. At this timing, the time stamp processing unit 307B of the time control unit 301B generates the time stamp value 312 according to the time information 315 output from the time counter unit 309B. The control unit 201 retains the time stamp value 312 as time T1 in the storage unit 204.

In step S704, the control unit 201 determines whether it is time to transmit a Follow Up packet. In a case where the control unit 201 determines that it is time to transmit a Follow Up packet (YES in step S704), the processing proceeds to step S705. In a case where the control unit 201 determines that it is not time to transmit a Follow Up packet (NO in step S704), the processing proceeds to step S707.

In step S705, the control unit 201 creates a Follow Up packet including information about the time T1 via the PTP processing software 404.

In step S706, the control unit 201 transmits the Follow Up packet including the information about the time T1 to the camera 104 or 105 via the wireless network 120. The time T1 is an example of time information based on a value output from the time counter unit 309B of the time control unit 301B for execution of the common synchronization processing. The time T1 is time information based on a value that has been output from the time counter unit 309B when the Sync packet has been transmitted to the camera 104 or 105.

In step S707, the control unit 201 determines whether a Delay Request packet is received from the camera 104 or 105 by the wireless communication unit 251 via the wireless network 120. In a case where a Delay Request packet is received (YES in step S707), the processing proceeds to step S708. In a case where a Delay Request packet is not received (NO in step S707), the processing proceeds to step S710.

In step S708, the wireless communication unit 251 asserts the transmission/reception interrupt signal 208 at a timing when reception of the Delay Request packet is completed. At this timing, the time stamp processing unit 307B of the time control unit 301B generates the time stamp value 312 according to the time information 315 output from the time counter unit 309B. The control unit 201 retains this time stamp value 312 as time T4 in the storage unit 204.

In step S709, the control unit 201 creates a Delay Response packet including information about the time T4. Then, the control unit 201 transmits the Delay Response packet including the information about the time T4 to the camera 104 or 105, who has transmitted the Delay Request packet, by the wireless communication unit 251 via the wireless network 120. The time T4 is an example of the time information based on a value output from the time counter unit 309B of the time control unit 301B for execution of the common synchronization processing. The time T4 is time information based on a value that has been output from the time counter unit 309B when the Delay Request packet has been received from the camera 104 or 105.

In step S710, the control unit 201 determines whether an end condition is satisfied. In a case where the end condition is not satisfied (NO in step S710), the processing returns to step S701. In a case where the end condition is satisfied (YES in step S710), the processing in the flowchart in FIG. 7 is ended.

The common synchronization method has been described. Because a time stamp is generated every time the transmission/reception interrupt signal 208 is asserted, it is necessary to appropriately execute processing for deleting unnecessary time stamps. In this processing, the above-described processing can be omitted if the wireless communication unit 251 includes a configuration for changing the interruption method depending on types of packets, and the configuration is utilized. However, detailed descriptions thereof are omitted because it is not a main part of the present embodiment. The synchronization processing in FIG. 7 has been described.

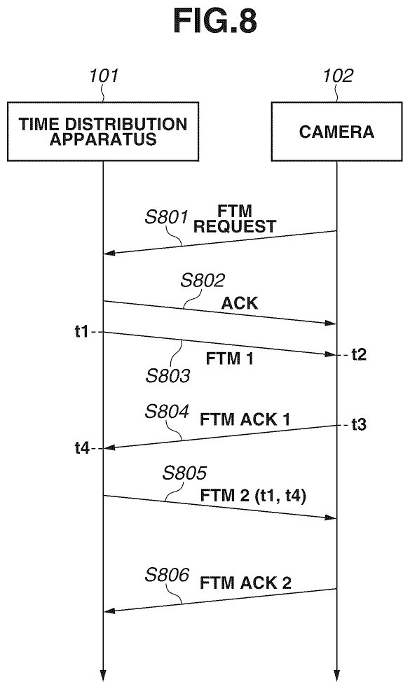

The wireless synchronization method is described with reference to FIG. 8. A synchronization method using Fine Time Measurement (FTM) defined in IEEE 802.11mc is described as an example of the wireless synchronization method.

In step S801, the camera 102 transmits an FTM request packet. The time distribution apparatus 101 receives the FTM request packet.

In step S802, the time distribution apparatus 101 transmits an Acknowledgement (ACK) packet. The camera 102 receives the ACK packet.

In step S803, the time distribution apparatus 101 transmits an FTM1 packet at a time t1. The camera 102 receives the FTM1 packet at a time t2.

In step S804, the camera 102 transmits an FTM ACK1 packet at a time t3. The time distribution apparatus 101 receives the FTM ACK1 packet at a time t4.

In step S805, the time distribution apparatus 101 transmits an FTM2 packet including information about the times t1 and t4. The camera 102 receives the FTM2 packet including the information about the times t1 and t4.

In step S806, the camera 102 transmits an FTM ACK2 packet. The time distribution apparatus 101 receives the FTM ACK2 packet.

The above-described FTM transmission/reception is repeated for a plurality of times. The time distribution apparatus 101 stores a timing when the FTM packet is transmitted, as time t1, and stores a timing when the FTM ACK packet is received, as time t4. Then, in step S805, the time distribution apparatus 101 transmits an FTM (i.e., FTM2) packet together with the information about the times t1 and t4 of the previous transmission/reception.

The camera 102 stores a timing when the FTM1 packet is received in step S803, as the time t2, and stores a timing when an FTM ACK1 packet is transmitted in step S804, as the time t3. By the above-described processing, the camera 102 is able to acquire the information about the times t1, t2, t3, and t4.

Similar to the above-described common synchronization method, the camera 102 is able to correct the time of the camera 102 by using the information about the times t1 to t4. In this way, time indicated by the clock included in the camera 102 is able to be adjusted to time indicated by the clock included in the time distribution apparatus 101.

The camera 102 is able to improve its accuracy by executing acquisition of times t1 to t4 and calculation for a plurality of times. The synchronization method illustrated in FIG. 8 has been described.

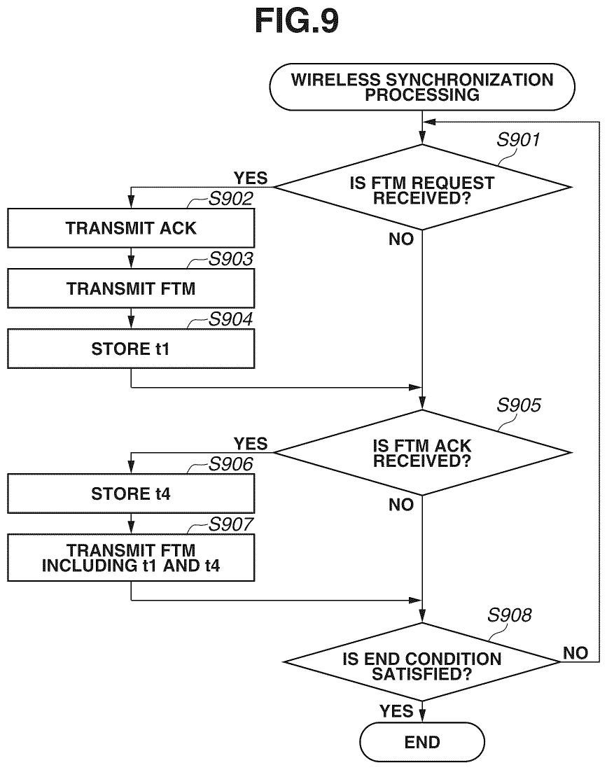

FIG. 9 is a flowchart illustrating details of the wireless synchronization processing executed in step S502 of FIG. 5. The entire processing is executed by the wireless control packet processing unit 254 included in the wireless communication unit 251.

In step S901, the wireless control packet processing unit 254 determines whether an FTM request packet is received from the camera 102 or 103 via the wireless network 110. The cameras 102 and 103 are examples of the external apparatuses. In a case where the wireless control packet processing unit 254 determines that an FTM request packet is received (YES in step S901), the processing proceeds to step S902. In a case where the wireless control packet processing unit 254 determines that an FTM request packet is not received (NO in step S901), the processing proceeds to step S905.

In step S902, the wireless control packet processing unit 254 functions as a transmission unit to transmit an ACK packet to the camera 102 or 103 via the wireless network 110.

In step S903, the wireless control packet processing unit 254 transmits an FTM packet to the camera 102 or 103 via the wireless network 110.

In step S904, the wireless control packet processing unit 254 saves the time information 255 output from the time counter unit 309A of the time control unit 301A when the FTM packet is transmitted, as time t1.

In step S905, the wireless control packet processing unit 254 determines whether an FTM ACK packet is received from the camera 102 or 103 via the wireless network 110. In a case where the wireless control packet processing unit 254 determines that an FTM ACK packet is received from the camera 102 or 103 (YES in step S905), the processing proceeds to step S906. In a case where the wireless control packet processing unit 254 determines that an FTM ACK packet is not received from the camera 102 or 103 (NO in step S905), the processing proceeds to step S908.

In step S906, the wireless control packet processing unit 254 stores the time information 255 output from the time counter unit 309A of the time control unit 301A when the FTM ACK packet is received, as time t4.

In step S907, the wireless control packet processing unit 254 transmits an FTM packet including information about the times t1 and t4 to the camera 102 or 103 via the wireless network 110.

The times t1 and t4 are examples of time information based on a value output from the time counter unit 309A of the time control unit 301A for execution of the wireless synchronization processing. The time t1 is time information based on a value that has been output from the time counter unit 309A when the FTM packet has been transmitted to the camera 102 or 103. The time t4 is time information based on a value that has been output from the time counter unit 309A when the FTM ACK packet has been received from the camera 102 or 103.

In step S908, the wireless control packet processing unit 254 determines whether an end condition is satisfied. In a case where the wireless control packet processing unit 254 determines that the end condition is not satisfied (NO in step S908), the processing returns to step S901. In a case where the wireless control packet processing unit 254 determines that the end condition is satisfied (YES in step S908), the processing illustrated in the flowchart in FIG. 9 is ended.

The above-described processing is continuously executed until the end condition is satisfied (YES in step S908). The processing illustrated in FIG. 9 has been described.

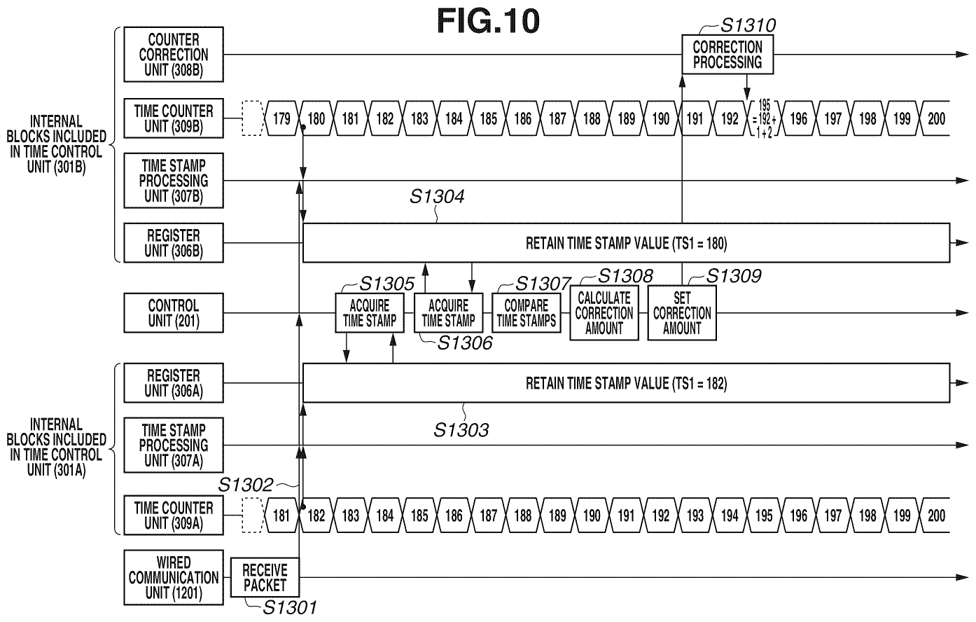

FIG. 10 is a timing chart illustrating details of the time adjustment processing in step S503 in FIG. 5. FIG. 10 is a timing chart illustrating the operations that are executed by the respective processing blocks as time passes, and a horizontal axis expresses passage of time.

In step S1001, the control unit 201 starts time adjustment processing by transmitting a generation request of the image capturing timing signal 209 to the time control unit 301B.

In step S1002, the register unit 306B of the time control unit 301B receives the generation request of the image capturing timing signal 209.

In step S1003, the time counter unit 309B increments a counter value as time passes.

In step S1004, the timing signal generation unit 310B starts executing the processing for generating a timing signal. The description is given of an example case in which the request is set in such a manner that the timing signal generation unit 310B is requested to generate the image capturing timing signal 209 every time a counter value output from the time counter unit 309B becomes a multiple of 20. In this case, the timing signal generation unit 310B generates the image capturing timing signal 209 every time a value output from the time counter unit 309B becomes a predetermined multiple.

In step S1006, the timing signal generation unit 310B asserts the image capturing timing signal 209 at a timing when a counter value output from the time counter unit 309B becomes 180 (i.e., at a generation timing of the image capturing timing signal 209). The timing signal generation unit 310B transmits the image capturing timing signal 209 to the control unit 201 and the time control unit 301A.

In step S1007, the time counter unit 309A increments the counter value as time passes.

In step S1008, in response to the time stamp processing unit 307A of the time control unit 301A receiving the image capturing timing signal 209, the time stamp processing unit 307A acquires the time information 315 (value=182) output from the time counter unit 309A at the time point of reception.

In step S1009, the time stamp processing unit 307A transmits the time information 315 (value=182) to the register unit 306A.

In step S1010, the register unit 306A retains the time information 315 (value=182) as a time stamp value.

In steps S1011 to S1013, in response to the control unit 201 detecting that the image capturing timing signal 209 is asserted, the control unit 201 acquires the time stamp value from the register unit 306A.

The control unit 201 may acquire the time stamp value in step S1014. In step S1014, the control unit 201 knows that a timing when the image capturing timing signal 209 is asserted corresponds to a value output from the time counter unit 309B is 180.

Thus, the control unit 201 may use a value calculated from that value, as a time stamp value. In a case where the time control unit 301B is able to retain a time stamp value at a timing when the image capturing timing signal 209 is asserted, the control unit 201 may acquire the value as a time stamp value.

In step S1015, the control unit 201 acquires a value (=180) output from the time counter unit 309B at a timing in step S1006 and a value (=182) output from the time counter unit 309A, and compares the two values. In this example, the value (=180) output from the time counter unit 309B is delayed from the value (=182) output from the time counter unit 309A by 2.

In step S1016, based on a result of the comparison, the control unit 201 calculates a correction amount. In this example, the control unit 201 simply uses the offset correction. In other words, the control unit 201 directly acquires 2, i.e., the comparison result, as a correction amount.

In steps S1017 and S1018, the control unit 201 sets the correction amount to the counter correction unit 308B.

In steps S1019 and S1020, the counter correction unit 308B adds 3, i.e., a value acquired by adding the correction amount 2 to the original addition value 1, to a value (192) output from the time counter unit 309B originally incremented by 1. Then, the counter correction unit 308B executes correction to set 195, a value as an addition result, to the time counter unit 309B.

The counter correction unit 308B executes correction for matching a value output from the time counter unit 309A and a value output from the time counter unit 309B to each other. The counter correction unit 308B executes correction every time a value output from the time counter unit 309B becomes a predetermined multiple (e.g., a multiple of 20).

In steps S1021 to S1024, the time distribution apparatus 101 repeatedly executes processing similar to the above-described processing by using the assertion of the image capturing timing signal 209 as a trigger. By the above-described processing, it is possible to constantly adjust the time even in a case where the values output from the time counter units 309A and 309B become different for some reason, e.g., minute differences between advance amounts. The timing chart illustrated in FIG. 10 has been described.

In the first embodiment, both the two synchronization methods are used in the wireless communication networks. Further, as a method for adjusting the time of the two synchronization methods, a method using a periodical image capturing timing signal 209 has been described.

In a second embodiment, a configuration using both wireless and wired networks is described. In the present embodiment, a time adjustment method using a signal different from the image capturing timing signal 209 which is periodical is described.

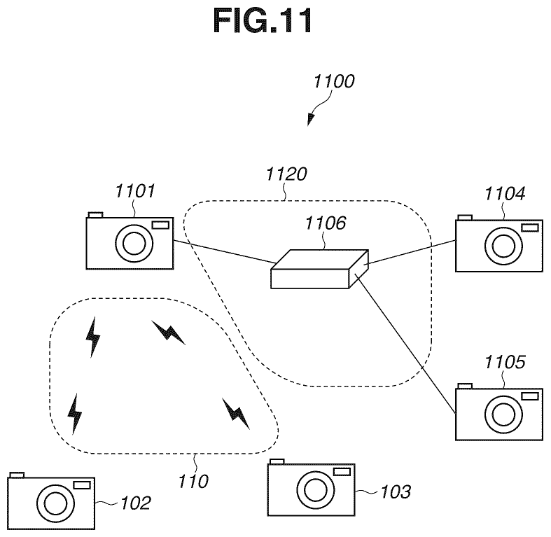

FIG. 11 is a diagram illustrating a configuration example of a synchronized image capturing system 1100 according to the present embodiment.

The synchronized image capturing system 1100 includes a time distribution apparatus 1101, a plurality of cameras 102, 103, 1104, and 1105, a wireless network 110, and a wired network 1120. The wired network 1120 includes a hub 1106. The cameras 102 and 103 and the wireless network 110 are similar to those illustrated in FIG. 1.

The time distribution apparatus 1101 is able to use the wireless network 110 and the wired network 1120 simultaneously, and executes synchronization processing with the four cameras 102, 103, 1104, and 1105. The cameras 1104 and 1105 support a wired LAN, and the cameras 1104 and 1105 are connected to the time distribution apparatus 1101 via the hub 1106 supporting PTP.

The time distribution apparatus 101 communicates with the cameras 102 and 103 via the wireless network 110 to execute the wireless synchronization processing. The time distribution apparatus 101 communicates with the cameras 1104 and 1105 via the wired network 1120 to execute the common synchronization processing. The synchronized image capturing system 1100 illustrated in FIG. 11 has been described.

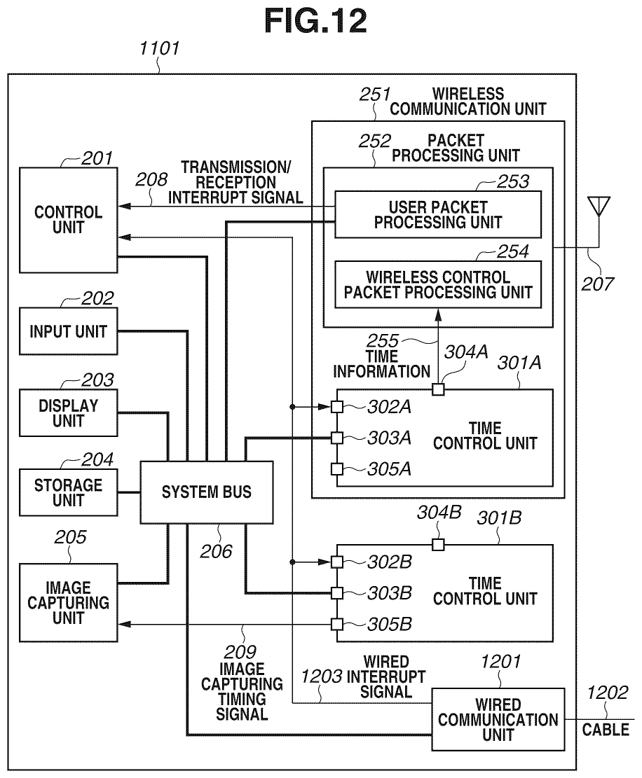

FIG. 12 is a block diagram illustrating a configuration example of the time distribution apparatus 1101 in FIG. 11. The points of difference between the time distribution apparatus 1101 in FIG. 12 and the time distribution apparatus 101 in FIG. 2 are only described. The time distribution apparatus 1101 in FIG. 12 includes a wired communication unit 1201 in addition to the units included in the time distribution apparatus 101 in FIG. 2.

The wired communication unit 1201 executes communication supporting a wired LAN. The wired communication unit 1201 is connected to an external device, such as the hub 1106, via a cable 1202. The wired communication unit 1201 notifies a wired interrupt signal 1203 to the control unit 201 at a timing when transmission/reception of a packet is executed.

Each of the time control unit 301A and the time control unit 301B acquires a time stamp value at a timing when the wired interrupt signal 1203 is asserted. The control unit 201 is able to acquire time stamp values respectively generated by the time control units 301A and 301B via the system bus 206. The configuration example illustrated in FIG. 12 has been described. In this configuration, wired control software is added to pieces of software executed by the control unit 201. Pieces of software other than the wired control software are similar to the above-described software.

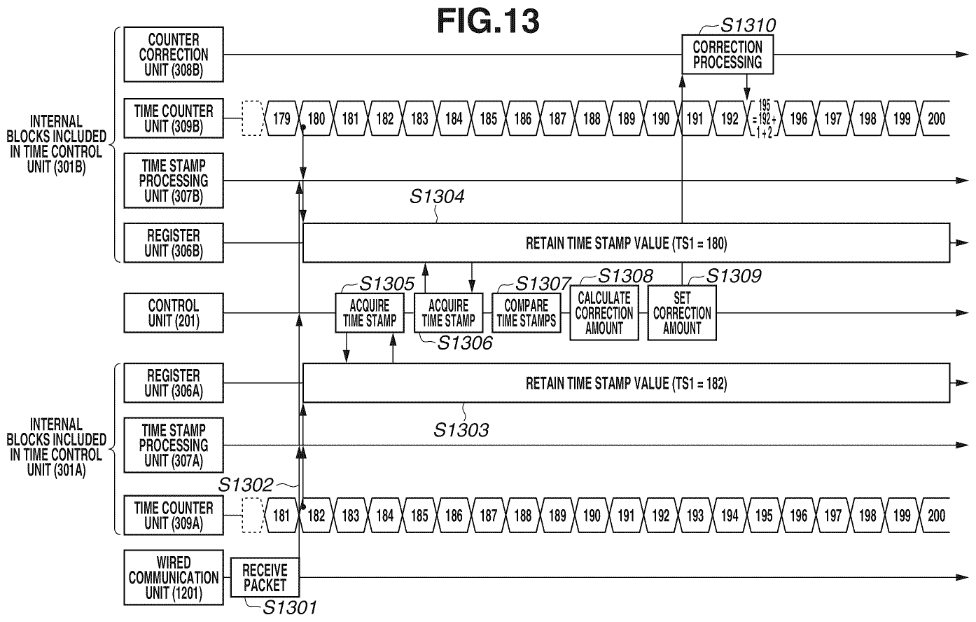

FIG. 13 is a timing chart illustrating the time adjustment processing that is executed by the time distribution apparatus 1101 in step S503 in FIG. 5. Similar to FIG. 10, a horizontal axis of the timing chart in FIG. 13 expresses passage of time. The main points of difference between the timing chart in FIG. 13 and the timing chart in FIG. 10 is described. Time adjustment processing is started by the wired interrupt signal 1203 output from the wired communication unit 1201.

In step S1301, the wired communication unit 1201 receives a packet from the camera 1104 or 1105.

In step S1302, the wired communication unit 1201 notifies the wired interrupt signal 1203 to the control unit 201, the time stamp processing unit 307A, and the time stamp processing unit 307B.

While the wired communication unit 1201 uses reception of a packet as a trigger, the wired communication unit 1201 may use the wired interrupt signal 1203 for transmission of a packet as a trigger. The notification in step S1302 may be executed separately from the wired interrupt signal 1203. For example, the notification may be executed at a timing only when a specific packet, such as PTP, is transmitted/received.

In step S1303, the register unit 306A retains a value (=182) output from the time counter unit 309A at a timing when the time stamp processing unit 307A receives the notification, as a time stamp value.

In step S1304, the register unit 306B retains a value (=180) output from the time counter unit 309B at a timing when the time stamp processing unit 307B receives the notification, as a time stamp value.

In step S1305, the control unit 201 acquires the time stamp value from the register unit 306A.

In step S1306, the control unit 201 acquires the time stamp value from the register unit 306B.

The processing in steps S1307 to S1310 is similar to the processing in steps S1015 to S1019 in FIG. 10. In step S1307, the control unit 201 compares the two time stamp values. In step S1308, the control unit 201 calculates a correction amount. While the offset correction method is used in the first embodiment, it is desirable to use a frequency correction method in a case where a correction amount is considerably small. Further, using an absolute value correction method may be desirable in a case where a synchronized state is once cancelled for some reason, and a correction amount is increased. Selection of the correction method and calculation of the correction amount may be executed by using statistical information describing transition of the past correction results.

In step S1309, the control unit 201 sets the correction amount to the counter correction unit 308B via the register unit 306B.

In step S1310, the counter correction unit 308B executes actual correction processing. The counter correction unit 308B executes correction according to a timing when a packet is transmitted or received via the wired network 1120 in step S1301. The counter correction unit 308B may execute correction according to a timing when a specific packet is received or transmitted. The timing chart illustrated in FIG. 13 has been described.

A third embodiment is described. In order to execute synchronized-time image capturing, each of the cameras has to have a synchronization function. In a case where the time distribution apparatuses 101 and 1101 according to the first and the second embodiments are used, processing that is executed by cameras is also able to be performed. However, in terms of the synchronization function, the time distribution apparatus 101 (1101) has to include software for causing the time distribution apparatus 101 (1101) to operate as a synchronization destination, not as a synchronization source (distributor).

In the above-described embodiments, a method for correcting time of the time control unit 301B has been described. However, a method for correcting time of the time control unit 301A is also able to be used. In a case where there is a difference between the functions of the time control units 301A and 301B, which time is to be used as a synchronization source may be determined depending on the difference between the functions. Alternatively, a synchronization network established earlier than the other may be determined as a synchronization source. Furthermore, a synchronization source may be determined depending on accuracy of respective oscillators that are used for the time control units 301A and 301B to generate operation pulses 316.

The time control units 301A and 301B may be arranged in one integrated circuit (IC) or may individually be arranged in different ICs. For example, in FIG. 2, the wireless communication unit 251 may be configured of a single IC. In the first and the second embodiments, the image capturing timing signal 209 is generated by using a function included in the time control unit 301B. However, the time control unit 301A may include and use a similar function.

In the first and the second embodiments, the time information output port 304B is not used. For example, in the second embodiment, in a case where the wired communication unit 1201 is able to acquire a time stamp value, the wired communication unit 1201 may receive time information for acquiring the time stamp value via the time information output port 304B.

While the wireless synchronization method using FTM stipulated in IEEE 802.11mc has been described, another control/management frame is also able to be used in a case where a time stamp value of a specific packet is usable.

While the two synchronization methods, i.e., the common synchronization method and the wireless synchronization method, have been described in the first and the second embodiments, other methods is also usable. For example, in a case where a synchronization method, such as Synchronous Ethernet (SYNCE), expected to be used in wired communication, is usable for the wired communication unit 1201, the synchronized image capturing system may support two modes, i.e., a wired synchronization method and a wireless synchronization method. Depending on a system configuration, only one synchronization mode may be operated from among the plurality of synchronization modes.

As described above, according to the first to the third embodiments, the synchronized image capturing system 100 or 1100 is able to support a plurality of time distribution methods with the single time distribution apparatus 101 or 1101. Further, the time distribution apparatus 101 or 1101 is able to reduce a difference in time information between the time distribution methods and accurately synchronize time of many cameras (communication devices) 102 to 105 and 1104 to 1105.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-101992, filed Jun. 25, 2024, which is hereby incorporated by reference herein in its entirety.

What is claimed is:

1. A time distribution apparatus comprising:
a first transmission unit configured to transmit, to a first external apparatus, time information based on a value of a first time counter for a first synchronization processing;
a second transmission unit configured to transmit, to a second external apparatus, time information based on a value of a second time counter for a second synchronization processing; and
a correction unit configured to execute correction to match the value of the first time counter and the value of the second time counter to each other.

2. The time distribution apparatus according to claim 1,
wherein the first transmission unit transmits the time information based on the value of the first time counter via a first wireless network, and
wherein the second transmission unit transmits the time information based on the value of the second time counter via a second wireless network.

3. The time distribution apparatus according to claim 1,
wherein the first transmission unit transmits the time information based on the value of the first time counter via a wireless network, and
wherein the second transmission unit transmits the time information based on the value of the second time counter via a wired network.

4. The time distribution apparatus according to claim 1,
wherein the first transmission unit transmits the time information based on the value of the first time counter by a first synchronization method, and
wherein the second transmission unit transmits the time information based on the value of the second time counter by a second synchronization method different from the first synchronization method.

5. The time distribution apparatus according to claim 4, wherein the second synchronization method is a synchronization method using Precision Time Protocol.

6. The time distribution apparatus according to claim 4,
wherein the first synchronization method is a synchronization method using Fine Time Measurement, and
wherein the second synchronization method is a synchronization method using Precision Time Protocol.

7. The time distribution apparatus according to claim 6,
wherein the first transmission unit transmits, to the first external apparatus, time information based on a value that has been output from the first time counter when a Fine Time Measurement packet has been transmitted to the first external apparatus and time information based on a value that has been output from the first time counter when a Fine Time Measurement acknowledgement packet has been received from the first external apparatus, and
wherein the second transmission unit transmits, to the second external apparatus, time information based on a value that has been output from the second time counter when a Synchronization packet has been transmitted to the second external apparatus and time information based on a value that has been output from the second time counter when a Delay Request packet has been received from the second external apparatus.

8. The time distribution apparatus according to claim 1, further comprising an image capturing unit configured to execute image capturing processing based on an image capturing timing signal based on the value of the second time counter.

9. The time distribution apparatus according to claim 8, wherein the correction unit executes the correction according to a generation timing of the image capturing timing signal.

10. The time distribution apparatus according to claim 8, further comprising a timing signal generation unit configured to generate the image capturing timing signal every time a value output from the second time counter becomes a predetermined multiple.

11. The time distribution apparatus according to claim 1,
wherein the first transmission unit transmits, to the first external apparatus, time information based on a value that has been output from the first time counter when a first packet has been transmitted to the first external apparatus and time information based on a value that has been output from the first time counter when a second packet has been received from the first external apparatus, and
wherein the second transmission unit transmits, to the second external apparatus, time information based on a value that has been output from the second time counter when a third packet has been transmitted to the second external apparatus and time information based on a value that has been output from the second time counter when a fourth packet has been received from the second external apparatus.

12. The time distribution apparatus according to claim 1, wherein the correction unit executes the correction every time a value output from the second time counter becomes a predetermined multiple.

13. The time distribution apparatus according to claim 1, wherein the correction unit executes the correction based on a reception timing or a transmission timing of a packet received or transmitted via a wired network.

14. The time distribution apparatus according to claim 13, wherein the correction unit executes the correction based on a reception timing or a transmission timing of a specific packet.

15. A synchronized image capturing system comprising:
the time distribution apparatus according to claim 1;
the first external apparatus; and
the second external apparatus,
wherein the first external apparatus executes image capturing based on the first synchronization processing, and
wherein the second external apparatus executes image capturing based on the second synchronization processing.

16. A method of a time distribution apparatus, the method comprising:
transmitting, to a first external apparatus, time information based on a value of a first time counter for a first synchronization processing;
transmitting, to a second external apparatus, time information based on a value of a second time counter for a second synchronization processing; and
executing correction to match the value of the first time counter and the value of the second time counter to each other.

17. A non-transitory computer-readable storage medium storing a program causing a time distribution apparatus to execute a method, the method comprising:
transmitting, to a first external apparatus, time information based on a value of a first time counter for a first synchronization processing;
transmitting, to a second external apparatus, time information based on a value of a second time counter for a second synchronization processing; and
executing correction to match the value of the first time counter and the value of the second time counter to each other.
